(19) United States
(12) Patent Application Publication
(10) Pub. No.: US 2024/0052799 A1
(43) Pub. Date: Feb. 15, 2024

(54) JET VECTORING APPARATUS

(71) Applicant: The Secretary of State for Defence, Salisbury, Wiltshire (GB)

(72) Inventor: Peter Geoffrey Martin, Salisbury (GB)

(21) Appl. No.: 18/260,396

(22) PCT Filed: Dec. 1, 2021
(86) PCT No.: PCT/GB2021/000129

§ 371 Date: Jul. 5, 2023

(30) Foreign Application Priority Data
Jan. 8, 2021 (GB) 2100250.6

(51) Int. Cl. F02K 1/12; F02K 1/09

(52) U.S. Cl. CPC F02K 1/1207; F02K 1/09

(57) ABSTRACT

A jet vectoring apparatus has a nozzle (1) which comprises a throat aperture (8) and an exit aperture (9), the apparatus also having a post exit surface (10). Variation of at least one of the throat aperture (8), exit aperture (9) and post exit surface causes a pressure differential upon the post exit surface which permits the direction of propulsive jet flow (3) (also known as jet thrust) to be varied relative to the longitudinal axis (2) of the apparatus.

The present invention relates to apparatus and methods of jet vectoring (also commonly known as thrust vectoring), particularly for use with propulsive gas generators such as jet engines found on aircraft.

Jet vectoring is a broad term for changing the direction of thrust produced by an aircraft jet engine (or any form of propulsive gas generator such as a rocket), by changing the direction (and sometimes also the position) at which exhaust gases are exhausted. This can be used to create a turning moment or lifting force.

Jet vectoring can be used to enhance the turning of an aircraft during manoeuvres, providing additional turning force to that provided by the control surfaces, thus permitting the size and complexity of other control surfaces to be reduced. Accordingly, for some aircraft types, jet vectoring allows the overall aircraft complexity and weight to be reduced. Weight reduction is paramount in aircraft and permits increased range, improved agility or greater performance or a combination of these, depending on which characteristics are most desirable.

Jet vectoring permits, for example, longitudinal (pitching moment) and lateral (yawing moment) trim of the aircraft to be maintained without the need to use other control surfaces, and may obviate the need for some control surfaces entirely. At very high speeds this can result in a substantial aircraft drag reduction. At low speeds, for example during take-off and landing, other controls become less effective. During take-off, jet vectoring enables the nose of the aircraft to be raised earlier which reduces the length of the take-off run.

Gas generators have an axis which runs through the middle of the gas generator from front to back, or from top to bottom in the case of rockets. Exhaust gasses are normally expelled in line with this axis providing a thrust in the form of a jet flow, which will drive the gas generator substantially in the direction of this axis.

Known methods of jet vectoring include nozzles utilising one or more gimbal mechanisms which each permit rotation about one or more axes. Such nozzles can be mechanically rotated such that they are directed away from the axis of the gas generator to create a jet vector. Such mechanisms permit the jet flow to be directed, such that the thrust produced by the gas generator is no longer along its axis.

Such prior art mechanisms typically require complex, heavy and high powered electro-mechanical, hydraulic or pneumatic systems, and their integration alongside other aircraft systems may also be highly complex.

Minimising the complexity and weight of the engine or nozzle is highly desirable as this will reduce the size of aircraft required to perform a given mission. For aircraft designs which are sized by the length of the required take-off run or by turn-rate in combat, or where trim drag greatly impacts cruise or supersonic performance, vectoring functionality can in itself have an indirect beneficial effect on aircraft size.

Thus it is highly desirable to provide a jet engine with jet vectoring capability which mitigates all or some of the known drawbacks.

According to a first aspect of the invention there is provided a propulsive gas generator according to claim 1. Such apparatus allows a precise jet vector angle δ to be achieved in a simple, lightweight manner. Reducing unnecessary weight in an aircraft design is highly desirable as it allows inter alia reduced aircraft size for a given payload and mission. In the prior art, cooling must be provided to the majority, if not all, nozzle components. Known or proposed designs show that addressing all of these issues together in an integrated design has been a particular technical challenge when a large amount of articulation is required such as in a reheated, mechanical vectoring system. Thus an alternative which is simpler, lighter and easier to implement is desirable.

Preferably, at least one of the throat aperture area (A₈), exit aperture area (A₉) and post exit surface length (d) are configured to be varied in size by the control means, however the post-exit surface length (d) may also be fixed. Varying all three of these to achieve the jet vector provides maximum vectoring effectiveness whilst also allowing the throat or exit apertures to be varied for other purposes (e.g. maximising thrust or efficiency).

Preferably the post exit surface length (d) is configurable in size to between 0.5 and 1.5 times the fixed aperture size or maximum aperture size of the exit aperture (9). This range is relative to the fixed size (height e) of the exit 9 (if the exit aperture is not variable), or to the maximum size (height e) of the exit 9 (if the exit aperture is variable). Providing a post exit surface length d that is variable in this range relative to the exit 9 height e permits effective control of the range of jet vector angles δ that can be produced.

Preferably the post exit surface length (d) substantially matches the fixed aperture size or maximum aperture size of the exit aperture (9). Substantially matching the post exit surface length d to the fixed size (height e) of the exit 9 (if the exit aperture is not variable), or to the maximum size (maximum height e) of the exit 9 (if the exit aperture is variable) is simple to implement and permits a useful range of jet vector angles δ to be generated.

Preferably the nozzle (1) is adapted to be rotatable relative to the axis (2) of the propulsive gas generator. Combining the invention with a rotating nozzle enhances the range of jet vectors which can be achieved.

Preferably the post exit surface (10) is configurable to be enclosed at the sides. Enclosing the post exit surface 10 at the sides improves efficiency of the jet vectoring and reduces thrust lost through jet vectoring.

Preferably the post exit surface (10) is angled such that the distal end is closer to the axis (2) of the propulsive gas generator than the forward end. Angling the post exit surface (10) towards the axis (2) will further enhance the range of jet vector angles that can be achieved in one direction. Providing a post exit surface which is fixed at a particular angle provides a way to adjust the range of jet vectoring angles or increase the maximum angle possible in one direction. This is simple to implement as it does not require the post exit surface to be dynamically adjusted. For example, the surface may be fitted with an indexing mechanism which allows manual adjustment of the surface angle before flight e.g. a splined shaft permitting a range of angles of the surface to be configured. Such a surface may then be adjusted manually before a flight to the desired angle for the ensuing mission, with sensors to read the position and passing this information to the control means which can compensate accordingly. This is a simpler implementation than one which enables the angle of the post exit surface 10 to be dynamically adjusted in flight.

Preferably the post exit surface (10) is pivotable at the forward end such that the angle of the post exit surface (10) is variable with respect to the longitudinal axis (2) of the propulsive gas generator. Providing a post exit surface 10 with a variable angle permits a wider range of jet vectoring angles to be achieved, or for the possible range of jet vectoring angles to be adjusted. For example, if it is positioned below the exit 9, inclining it towards the longitudinal axis 2 will result in a greater range of jet vector angles which will raise the nose, i.e. maximising the largest possible jet vector angle δ which can be achieved, at the expense of angles which will cause the nose to drop.

Preferably the forward end of the post exit surface (10) is configurable to be positioned adjacent the exit aperture (9). This provides a simple and convenient way to enact the invention.

Preferably the exit aperture (9) is substantially circular in shape, and the forward end of the post exit surface (10) is configurable to be positioned adjacent an exterior circumference of the exit aperture (9). This position will produce a wide range of useful jet vector angles S to be produced.

Preferably the forward end of the post exit surface (10) is positioned adjacent the throat aperture (8). This allows rotation of the post exit surface (10) to both direct the jet flow (3) but also to vary the size of the exit aperture (9) thus causing further jet vectoring.

Preferably the forward end of the post exit surface (10) is positioned approximately centrally to the throat aperture (8). Such a position allows the jet exit (9) to be divided into two parts, permitting an expansion fan (30) to be generated in one part and an oblique shock wave (35) in the other part.

This mechanically simple arrangement may suit applications where nozzle operation in over-expansion is viable and may enhance the range or control of jet vectoring angles that may be achieved.

Preferably the post exit surface (10) is configured to be extendible to an operative position forming an asymmetric exit, and retractable to a stowed position forming a substantially symmetric exit. This allows it to be stowed when not required, which may be preferable for stealth, efficiency or other reasons, and prevent it interfering with the jet flow (3) when jet vectoring is not required. Additionally the same mechanism can be used to both retract/extend the post exit surface 10 and to change the post exit surface length d.

Preferably the gas generator comprises two or more post exit surfaces (10) each configured to be extendible to an operative position forming an asymmetric exit, and retractable to a stowed position forming a substantially symmetric exit. Providing two or more post exit surfaces (10) which can be independently controlled permits an enhanced range of jet vector angles to be achieved.

Preferably the nozzle (1) comprises the post exit surface (10). Providing the post exit surface 10 as a component of the nozzle would make implementation, testing and control easier.

Preferably the propulsive gas generator is a gas turbine. Implementing the invention in a gas turbine is useful as it is often beneficial for such turbines to provide jet vectoring.

Preferably an aircraft comprises a propulsive gas generator according to the invention. Aircraft benefit from jet vectoring, and providing jet vectoring in accordance with the invention on an aircraft may permit weight and complexity to be reduced. Providing the invention on an aircraft further provides the possibility of enhanced manoeuvring and improved mission effectiveness.

The present invention shall now be described, by way of example only, with reference to the accompanying drawings, in which:

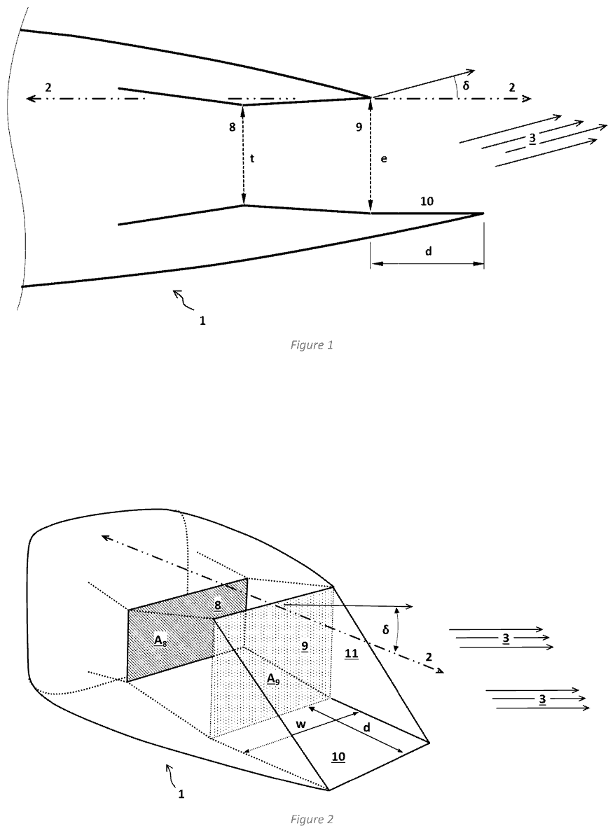

FIG. 1 is a part-cutaway side view of a jet engine nozzle according to the invention, viewed from the side, showing a jet vector angle δ being generated.

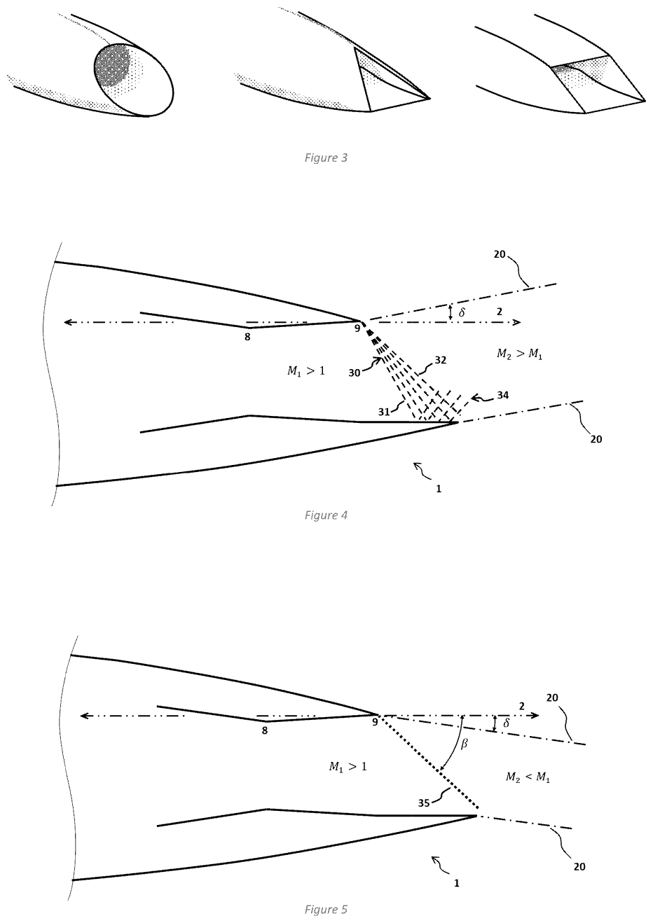

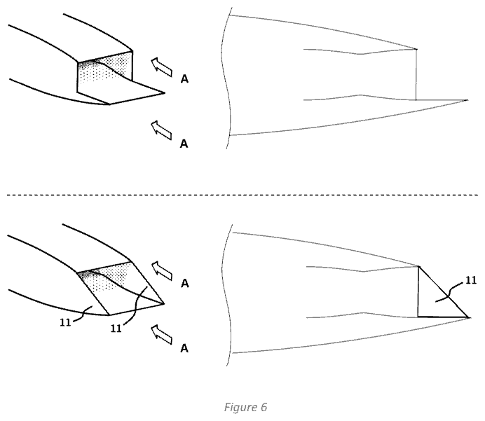

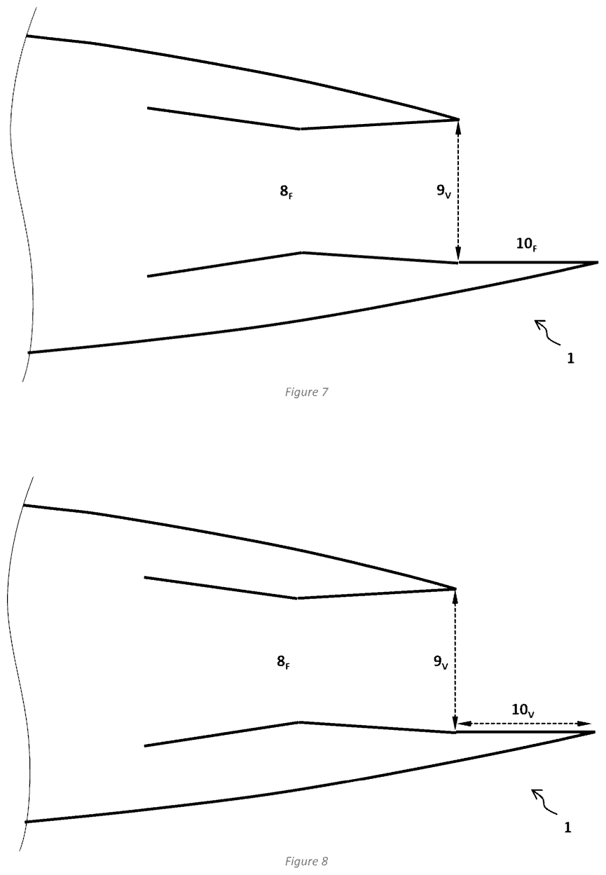

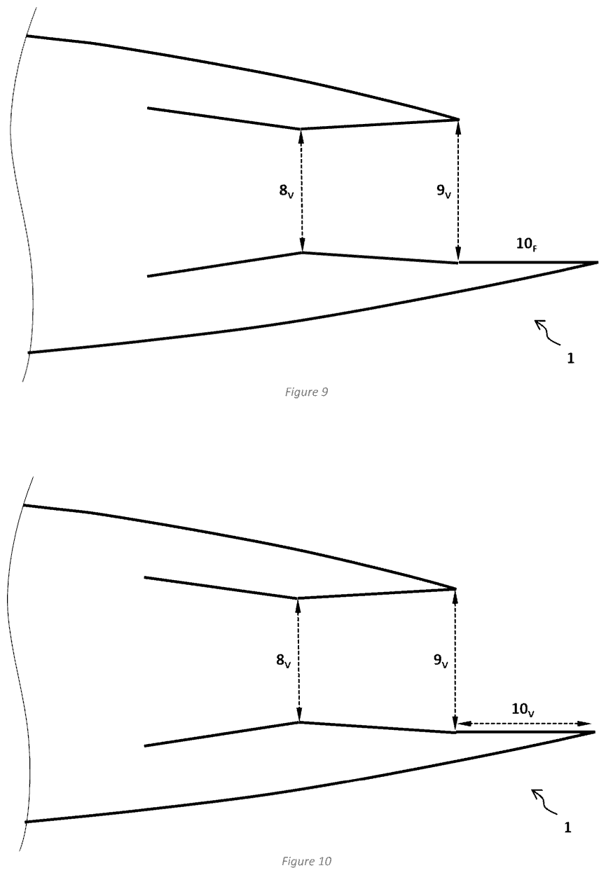

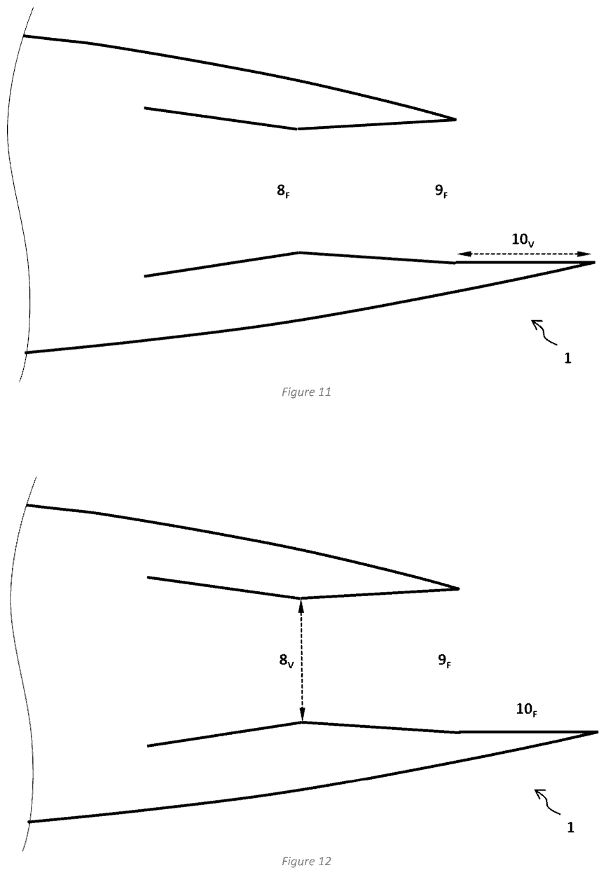

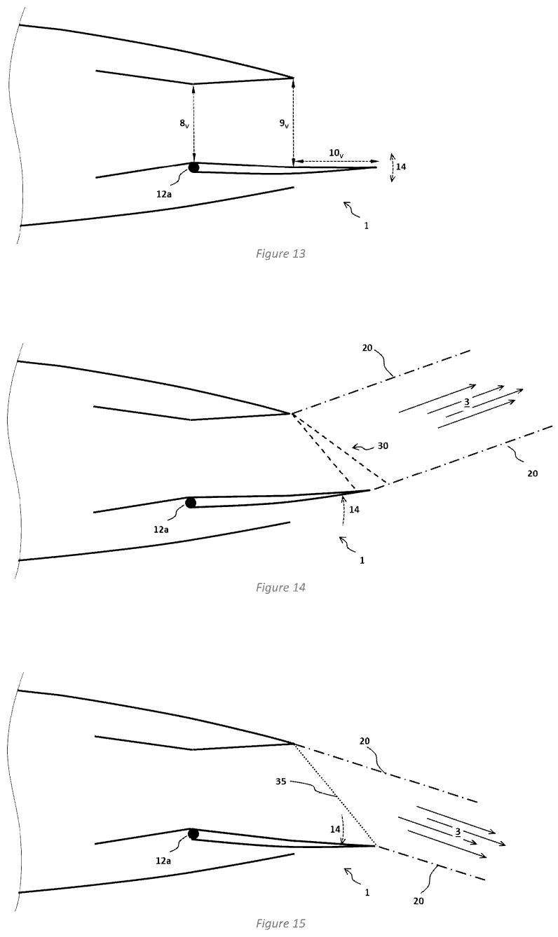

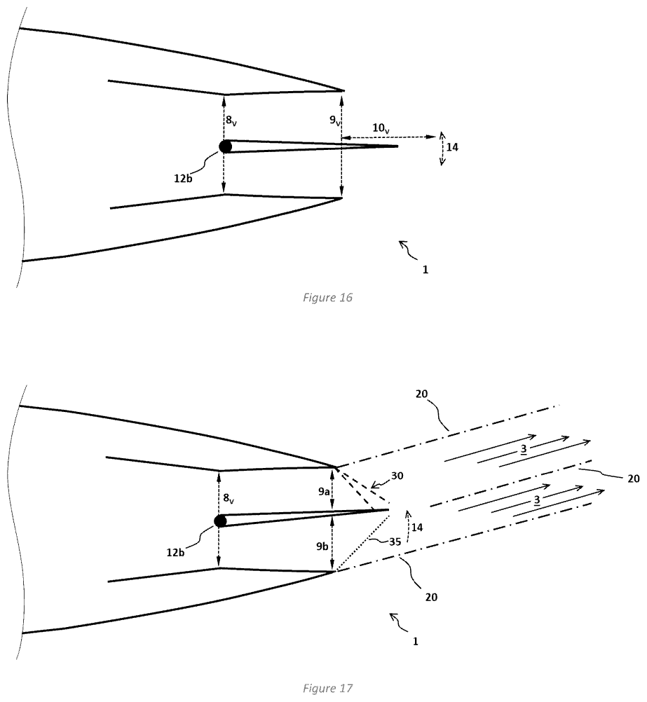

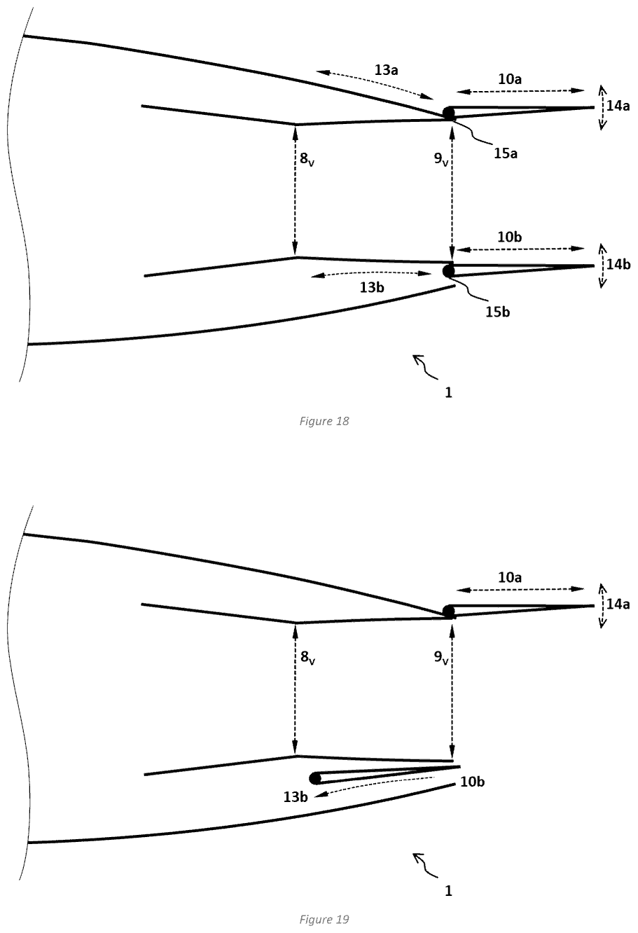

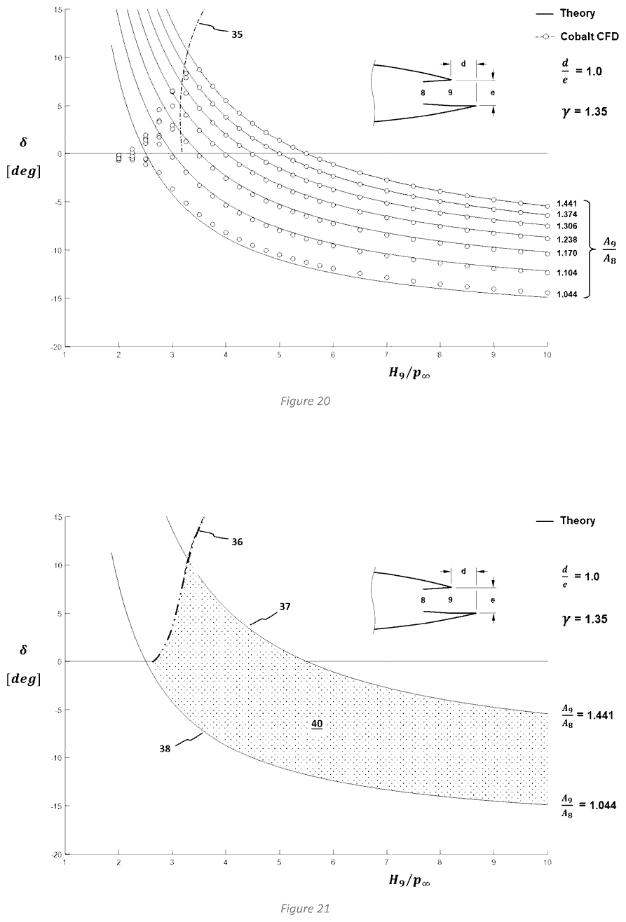

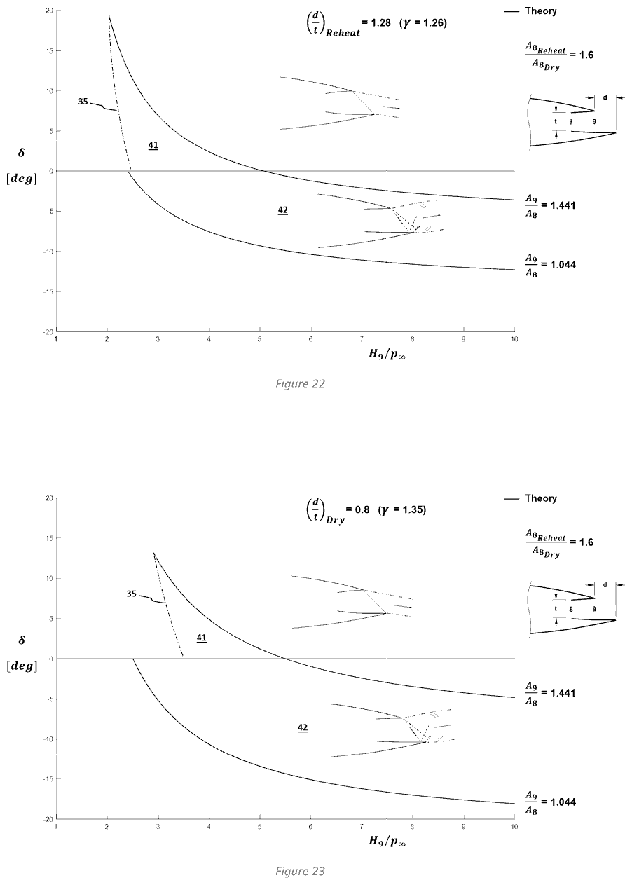

FIG. 2 is a perspective view of the jet engine nozzle shown in FIG. 1, showing a jet vector angle δ being generated. Dashed lines indicate hidden detail.

FIG. 3 is a perspective view of different nozzle geometries which are suitable for use with the invention.

FIG. 4 is a part cutaway side view of a jet engine nozzle according to the invention, depicting supersonic flow turning through a Prandtl-Meyer expansion fan FIG. 5 is a part cutaway side view of a jet engine nozzle according to the invention, depicting supersonic flow turning through a plane oblique shock wave.

FIG. 6 shows at the top a perspective view (top left) and a sectional view along the line A-A (top right) of an embodiment without side walls; and at the bottom a perspective view (bottom left) and sectional view along the line A-A (bottom right) of the an embodiment with post-exit side walls 11

FIG. 7 is a part cutaway view of a first embodiment of the invention

FIG. 8 is a part cutaway view of a second embodiment of the invention

FIG. 9 is a part cutaway view of a third embodiment of the invention

FIG. 10 is a part cutaway view of a fourth embodiment of the invention

FIG. 11 is a part cutaway view of a fifth embodiment of the invention

FIG. 12 is a part cutaway view of a sixth embodiment of the invention

FIG. 13 is a part cutaway view of a seventh embodiment of the invention

FIG. 14 is a further part cutaway view of a seventh embodiment of the invention, showing the post exit surface 10 rotated towards the longitudinal axis 2 causing an expansion fan 30.

FIG. 15 is a further part cutaway view of a seventh embodiment of the invention, showing the post exit surface 10 rotated away from the longitudinal axis 2 causing an oblique shock wave 35.

FIG. 16 is a part cutaway view of an eighth embodiment of the invention

FIG. 17 is a further part cutaway view of an eighth embodiment of the invention, showing the exit aperture 9 being subdivided into two separate parts acting as separate systems when the post exit surface 10 is rotated.

FIG. 18 is a part cutaway view of a ninth embodiment of the invention, with two separately-controllable post exit surfaces 10 which can each be pivoted and retracted.

FIG. 19 is a further part cutaway view of a ninth embodiment of the invention, showing one post exit surface retracted.

FIG. 20 shows a comparison of the variation of jet vector angle with nozzle pressure ratio predicted by two different methods

FIG. 21 shows the range of usable jet vector angles for a given range of nozzle geometries with constant exit height

FIG. 22 is a plot of jet vector angle δ against nozzle pressure ratio for a reheat power setting with constant nozzle throat height

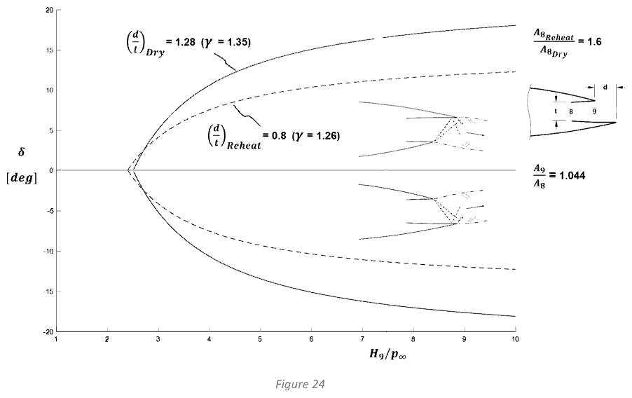

FIG. 23 is a plot of jet vector angle δ against nozzle pressure ratio for a dry power setting with constant nozzle throat height

FIG. 24 is a plot of jet vector angle δ against nozzle pressure ratio for a dry power setting with constant nozzle throat height, where nozzle geometry may be varied symmetrically

Like features are given like numerals in the figures.

The invention may be embodied in jet engines, and in particular may be beneficial when applied to civil or combat aircraft. Some embodiments of the invention are suitable for use with gas generators such as ramjets and rockets.

All embodiments of the invention are in the form of a jet engine suitable for mounting on an aircraft. The aircraft is not shown in the figures. Only the rear portion of the engine comprising the nozzle 1 is shown in the figures. Features of the engine prior to the throat aperture 8 are not shown.

In use, the engine disclosed in the embodiments may be mounted for example within the body of a combat aircraft, such that the nozzle 1 projects to the rear of the aircraft (not shown), just beyond the extent of the main aircraft body.

FIG. 1 and FIG. 2 show the general features of the invention as applied to a jet engine. The invention requires a nozzle with an internal constriction called the throat aperture 8 and a gas passage which widens towards an exit aperture 9 where the jet flow 3 exits. The invention also has a post exit surface 10, of which at least part extends beyond the exit aperture 9 towards the rear of the engine.

The exit aperture 9 is wider than the throat aperture 8, known in the art as a convergent-divergent nozzle.

It will be appreciated that the throat aperture 8 and exit aperture 9 have been given reference numerals commensurate with their usual “station” (i.e. position) within the engine, thus their numerals match the usual references given to them in the art.

With reference FIG. 1 and FIG. 2, the throat aperture 8 has a height t and area A₈, and the exit aperture has a height e and area A₉. The areas of the throat and exit apertures are the cross-sectional size of the opening in a plane normal to the longitudinal axis 2 at the throat aperture 8 and exit aperture 9 respectively.

Having a variable throat aperture 8 means that area A₈ can be varied, and having a variable exit aperture 9 means that area A₉ can be varied. Likewise, varying the throat aperture 8 means varying its area A₈ and varying the exit aperture 9 means varying its area A₉.

With reference to FIG. 2, the invention comprises a post exit surface 10 of length d and width w. This length d is the surface length in the general direction of the longitudinal axis, and the width being in the direction perpendicular to this.

The post exit surface 10 may be fixed in size or variable in size, and may be further configured to be retractable to a stowed position and extendible to an operative position. As seen in FIG. 1, which shows a non-retractable post exit surface 10, the nozzle 1 is asymmetric when viewed from the side (in this example it extends longer at the bottom than the top, so is not symmetric from the side). If the post exit surface 10 is retractable, the nozzle 1 is asymmetric when the surface is in the extended position and may be symmetric when it is in the retracted position.

The prior art nozzle is typically symmetric when viewed from the side.

As well as being optionally variable in length and optionally moveable to a stowable position, the post exit surface 10 is optionally pivotable at its forward end (the end towards the front of the gas generator) to raise or lower the distal end, or alternatively may be fixed in a position such that the distal end is closer to (or further from) the longitudinal axis than the forward end.

At least one of the throat aperture 8, exit aperture 9 and post exit surface 10 length d needs to be variable; whichever of the three components is variable is referred to as the active component(s). Deliberate and precise control of the active component(s) can vary the jet flow 3 away from axis 2 which is parallel to the longitudinal axis of the jet engine.

The result of this deliberate control of the active components is a controllable angle of the jet flow 3 with respect to axis 2. The angle of this jet flow 3 with respect to the axis 2 is defined as jet vector angle δ, measured here in degrees.

The invention may be worked whereby just one, just two or all three of the throat aperture 8, exit aperture 9 and post exit surface length d, are variable in both size and in their relative position.

For example, just the throat aperture 8 may be variable, just the exit aperture 9 or just the post exit surface length d may be variable.

Alternatively, just the exit aperture 9 and post exit surface length d may be variable; just the throat aperture 8 and post exit surface length d may be variable; or just the throat aperture 8 and exit aperture 9 may be variable.

Finally all three of the throat aperture 8, exit aperture 9 and post exit surface length d may be variable.

The post exit surface 10 needs to be configured so that it is positioned, or is moveable to a position, such that in use at least a portion projects beyond the exit aperture 9. The entirely of the post exit surface 10 does not need to project beyond the exit aperture 9 in use.

Where the post exit surface 10 is movable to a stowable position, it may be that none of it extends beyond the exit aperture 9 when in this stowed position. When it is moved back to an operable position, some or all of it should extend beyond the exit aperture 9.

There may be more than one post exit surface 10. There may be a plurality of post exit surfaces 10 around the periphery of the exit aperture 9.

The post exit 10 surface may be integrally formed with the nozzle 1 or a separate component. Providing the nozzle as a separate component is especially useful where it is moveable independently of the nozzle 1.

All embodiments herein comprise the post exit surface 10 as a component of the nozzle 1, rather than of the jet engine or of the aircraft. The post exit surface 10 may be provided as part of the nozzle 1, part of the overall engine, or as part of the aircraft. For example, the latter can be achieved by positioning the engine close to the rear of the aircraft or aircraft wing, leaving a portion of the aircraft or wing projecting beyond the exit aperture 9 of the engine in order to form the required surface.

With reference to FIG. 1 and FIG. 2, and in common with the prior art, air is taken in at the front of the jet engine. Thrust is generated by pressurising and heating the air flow passing through the engine, finally forming the resulting exhaust gas into a propulsive jet flow 3 at the rear. When jet vectoring is not desired, the jet flow 3 will (common with a typical non-vectoring engine of the art) be expelled broadly in line with this longitudinal axis 2 such that thrust is generated substantially along the longitudinal axis 2. This state can be achieved in the invention by varying the active component(s) and/or retracting any post exit surfaces 10.

The invention can be applied to any airborne gas generator such as a jet engine, ramjet or rocket. A jet engine is used as an example application herein.

A gas generator, such as a jet engine, incorporating the invention will end in a nozzle 1. As known in the art, the nozzle 1 has the dual function of controlling gas flow through the engine and forming this gas into a propulsive jet flow 3 in an efficient manner.

The nozzle 1 of each embodiment herein is substantially rectangular in cross section when viewed looking along the longitudinal axis (e.g. when viewed from the rear of the engine). However the nozzle 1 may be of any cross sectional shape, for example circular, elliptical, triangular, square or rectangular as graphically illustrated in FIG. 3. Whilst the examples given herein are all symmetrical, this is not a strict requirement.

As a typical example of how the invention may be employed, post exit surface length d may be fixed, with throat aperture A₈ and exit aperture A₉ variable. Then, deliberate variation of one or both the throat aperture and exit aperture can achieve the technical effect of the invention, i.e. generation of a jet vector angle δ and an associated force on post exit surface 10.

It is possible to simplify the application of the invention by having more than one active component, but temporarily fixing one of the active components for one or more flights. This permits system complexity to be reduced, whilst retaining a good degree of flexibility.

For example, the post exit surface 10, may be mechanically variable in angle (with respect to longitudinal axis 2) or length. But it may be fixed in position for one or more flights, after which it may be later adjusted in angle or length when it is accessible on the ground before another flight, in order to tune the performance envelope of the jet vectoring. Thus it will be appreciated that in the context of the active components, ‘fixed’ means not dynamically controlled in flight, rather than non-movable per-se.

By precisely and deliberately controlling the active component(s), the three components can be adjusted relative to each other enabling a precise jet vector to be achieved. This is done by deliberately creating a pressure differential on the post exit surface 10 relative to ambient pressure which creates a turning force on the engine and thus aircraft. It is not necessary that all three components can be independently varied, although such a configuration provides maximum flexibility.

The general principle of the invention is illustrated in FIG. 4 and FIG. 5.

FIG. 4 depicts supersonic flow turning through a Prandtl-Meyer expansion fan in accordance with the invention. This is achieved when the jet flow 3 is under expanded, i.e. pressure at the nozzle exit, station 9, is higher than ambient. This creates a jet vector angle δ and an associated downward force on the post exit surface 10. The size of the jet vector angle δ is dependent upon presence and the size of post exit surface 10, and the direction of the jet vector angle δ is dependent upon the position of the post exit surface 10.

With reference to FIG. 4, in a first region (1) between the throat aperture 8 and the exit aperture 9, the flow Mach number is greater than 1 (M₁>1), and in a second region (2) beyond the expansion fan 30 the flow Mach number is greater than that in the first region (M₂>M₁). The incipient Mach line 31 and terminal Mach line 32 are shown. The position of the expansion fan will depend on the Mach number at the exit 9 and the ratio of the pressure at 9 to ambient. Where all or part of the expansion fan impinges on the post-exit surface it will be partially reflected 34 and this will locally reduce the turning effect of the expansion fan. In some instances the incipient Mach line 31 may extend beyond the tip of the post-exit surface. In both of these situations there will be a reduction in the overall jet vector angle relative to the maximum that would be achievable if the geometry of the post-exit surface was ideally shaped to match that flow condition.

The Mach number of a gas is a term of art which is defined as flow velocity at a given point divided by the local speed of sound.

FIG. 5 depicts supersonic flow turning through a plane oblique shock wave 35. This is achieved when jet flow 3 is over expanded (i.e. at a lower pressure than ambient) which causes one or more oblique shock waves 35. This creates a jet vector angle δ and an associated (upward) force on the post exit surface 10. The size of the jet vector angle δ is dependent upon presence and the size of post exit surface 10, and the direction of the jet vector angle δ is dependent upon the position of the post exit surface 10.

Expansion fans, incipient Mach lines, terminal Mach lines and oblique shock waves are all terms which will be readily understood from the closely related field of fluid dynamics.

Thus the invention enables jet vectoring about one or more axis by exploiting (and optionally by controlling) under expanded and over-expanded flow states.

Thus, if a single post exit surface 10 is provided, a jet vector angle δ can be provided in either of two opposing directions (e.g. upwards and downwards). The range of possible jet vector angles δ in the under-expanded state is generally greater than the range of possible angles δ in the over-expanded state, so with a single post exit surface 10 there is a generally a wider range in one direction than the other.

Thus a configuration (not shown) where a post exit surface 10 can selectively be provided at the top or bottom of the exit aperture (for example), the total range of possible angles δ can be increased by permitting under expansion against either post exit surface 10 depending on which way the jet vector is required.

By providing moveable and retractable post exit surfaces 10 on the four sides of the exhaust (not shown), an even broader range jet vector angles δ are possible—i.e. upwards and downwards and also left and right. A plurality of independently moveable post exit surfaces 10 which can be moved as required around the whole periphery of the nozzle provides maximum flexibility.

The invention is in contrast to the prior art where typically the expansion state of the jet flow 3 is either uncontrolled (as in a convergent nozzle), or controlled to match ambient pressure (as in a convergent-divergent nozzle) primarily to maximise the production of thrust in a direction which is determined by the orientation of the exit aperture 9, which will typically be along the longitudinal axis 2. Unintended lateral forces may occur in such nozzles where there is some amount of asymmetry, but in the prior art nozzles are configured to minimise this behaviour rather than to exploit it.

The expansion state of the jet flow is dependent upon the ratio of nozzle exit area A₉ to throat area A₈ according to the engine operating condition and flight speed.

All embodiments of the invention exploit the expansion state of the jet flow 3 to create a jet vector angle δ and associated force on the post exit surface 10.

Several of the embodiments provide even greater control by also controlling the expansion state through variation of either or both of the throat aperture 8 and exit aperture 9.

Control of the post exit surface length d (and its angle and position), effect the magnitude and direction of the jet vector angle δ, thus can be used to further control the jet vector angle δ.

Ideally there all three components (the throat aperture 8, exit aperture 9 and post exit surface length d) may actively be controlled. This permits the expansion state of the jet flow 3 to be controlled as well as exploited, providing maximum flexibility in how the invention is employed. Further variation such as having multiple post exit surfaces 10, each independently retractable and each able to pivot at its forward end, provides even further flexibility and increased range and orientation of jet vectoring angles δ achievable.

However, control of only one of these three components is required. For example, the invention can be exploited on a rocket (or similarly a jet engine) wherein the throat aperture 8 and exit aperture 9 are both fixed and there are a plurality of post exit surfaces 10 that can be independently extended alongside the exit aperture 9, e.g. one at each of four sides. If the rocket travels at a specific speed any pressure differential between the jet flow 3 at the exit and ambient pressure can be exploited, by adjusting the length of the post exit surface 10 upon which the pressure differential acts. Depending on which post exit surface 10 is extended, the jet flow 3 at jet vector angle δ can be directed in any one of four directions, and the jet vector angle δ is dependent upon how far the post exit surface 10 is extended.

Thus with only one active component, the invention can be realised. A single post exit surface 10 in this example would still allow the invention to be realised, but only provide jet vectoring in one plane.

The theoretical maximum thrust available from a nozzle will be achieved when exit pressure p₉ and ambient pressure p_{∞} are matched, which may be achieved by varying the ratio of exit area A₉ to throat area A₈ according to the engine operating condition and aircraft flight condition. This optimal configuration wherein the exit pressure and ambient pressures are matched (i.e. at which the jet is said to be fully-expanded to ambient pressure), which the prior art seeks to achieve, corresponds to:

$$\frac{{p}_{9}}{{p}_{∞}} = \frac{{H}_{∞}}{{p}_{∞}} \cdot \frac{{H}_{9}}{{H}_{∞}} \cdot \frac{{p}_{9}}{{H}_{9}} = 1.$$

Where p is mean static pressure across a plane in the jet flow 3 at a given engine station (static pressure is the local pressure anywhere in the flow) and H is stagnation pressure (the local pressure which would result from bringing the flow to rest via an ideal isentropic process). Subscripts 9 and ∞ refer to conditions at the exit aperture 9 and ambient stations (i.e. ambient conditions in the vicinity of the exit), respectively.

H_{∞}/p_{∞} is a function of flight Mach number, i.e. aircraft speed relative to the local speed of sound, and will be measured continuously by the aircraft air data system and passed to the engine control system. H₉/H_{∞}, the overall propulsion system stagnation pressure ratio, is primarily a function of engine throttle setting and will be continuously measured by the engine control system. The required nozzle divergent area ratio (i.e. the area of the exit aperture A₉ relative to the throat aperture A₈) is related to H₉/p₉ alone, and for the target of p₉=p_{∞} this would be continuously determined from:

$$\frac{{H}_{9}}{{p}_{9}} = \frac{{H}_{∞}}{{p}_{∞}} \cdot \frac{{H}_{9}}{{H}_{∞}}$$

As is common to the art, a variable throat aperture 8 allows the back pressure to be maintained on the engine within a specified band across a range of engine throttle settings. In particular, where a jet engine employs a re-heat function (wherein fuel is injected before the throat to increase thrust), the throat aperture 8 needs to be enlarged during this re-heat to maintain this back-pressure. Where the reheat function is not employed, this is referred to as running ‘dry’. Such an engine will commonly also feature a variable exit aperture 9, which is varied to ensure that exhaust gases (i.e. the jet flow 3) are fully expanded in order to match ambient pressure.

Thus it is common in the art for the throat aperture area A₈ is to be adjusted in-flight, and for the exit aperture area A₉ to be adjusted accordingly to compensate, in order to achieve the idealised maximum thrust.

Thus a variable throat aperture 8 and exit aperture 9 are known in the art. These are controlled to maximise thrust and to ensure exhaust gases expand to match ambient pressure.

Where a variable throat aperture 8 or exit aperture 9 (or both) are already present this makes it relatively easy to retrofit the invention to existing designs.

In some forms of embodiment, where either the throat aperture 8 or exit aperture 9 are variable, this is achieved by a series of overlapping petals which are moved simultaneously to vary the appropriate area A₈ or A₉ respectively. This is not shown and is commonplace in the art.

The invention requires control means (not shown) which comprise an electronic control unit and actuating means in the form of mechanical (or otherwise) actuators for adjusting the active component(s). The active component(s) are controlled by the actuating means in response to a signal from the control means. The control means may receive an input signal directly from the pilot, or may receive the signal from the engine control system or aircraft flight control system.

As just discussed, it is common in the art to require both the exit aperture 9 and throat aperture 8 to be variable. This is done through associated actuators, which are usually controlled by the on-board flight control system or engine control system. The control means of the invention may be integrated with an existing aircraft control system, making the invention suitable for retrofitting to an existing aircraft by modifying the control system in the way that it controls existing actuators and components (and optionally adding further actuators e.g. to control the required post exit surface 10).

The post exit surface may be positioned with the forward end adjacent the throat aperture 8, for example mid-way up the throat aperture 8 or at a periphery of the throat aperture 8 (e.g. at the bottom). Then any rotation of the post exit surface 10 will also control the exit aperture 9, so may simplify or optimise the application of the invention.

Alternatively the post exit surface 10 may be positioned with the forward end adjacent the exit aperture.

Where the forward end of the post exit surface 10 is positioned adjacent bottom of the exit aperture 9 (“bottom” considered in light of the normal orientation of the engine when the aircraft is on the ground), this configuration provides a large range up “upward” (nose up) jet vector angles δ and a smaller range of “downward” (nose down) jet vector angles δ.

It will be appreciated that a jet vector direction which produces a nose-up pitching moment will be generally useful, allowing shorter take-off runs, enhanced control in turns or other manoeuvres and a means of achieving longitudinal aircraft trim at supersonic speeds. This position of the post exit surface 10 is only illustrative—alternatively the post exit surface 10 can be positioned on any position tangential to the circumference of the exit aperture 9 e.g. on the top or left or right, rather than at the bottom; or in other positions such as described in the following embodiments.

When positioned at the bottom of the exit aperture 9, angling the distal end of the post exit surface 10 towards the axis 2 of the engine will increase the range of upwards jet vector angles that are available (at the expense of downwards jet vector angles δ). This may be highly beneficial in some applications.

As mentioned, the post exit surface 10 may optionally be angled (i.e. inclined or declined) with respect to the longitudinal axis, to adjust the range of jet vector angles δ possible for a particular embodiment of the invention. For example, this can be used to increase the maximum jet vector angle δ that can be achieved in a particular direction.

As mentioned, the post exit surface 10 may optionally be pivotable at its forward end, allowing dynamic adjustment of the range of jet vectoring angles δ possible. This pivoting may be dynamic during flight, or implemented via e.g. mounting the post exit surface 10 on a splined shaft so that it can be rotated to a new position when the jet engine is on the ground (i.e. rotatable, if required, between flights).

Ideally the exit nozzle is enclosed at the sides by side walls 11 but this is not required. This constrains the fluid flow and maximises the jet vector angle δ that can be achieved. This is shown in FIG. 6. For example, this may be achieved by parallel side walls 11 at each side of the exit aperture 9, sloping from the top of the exit aperture 9 to the end the post exit surface 10 to partially enclose the post exit surface 10.

The side walls 11 if present, may optionally be retractable alongside the nozzle by a similar mechanism to the post exit surface 10 e.g. linear actuators.

The post exit surface 10 may be scooped, i.e. curved towards the longitudinal axis along its length. Providing a curvature to the post exit surface may be beneficial for enhancing the jet vectoring capability and for making it easier to manoeuvre and stow since it can be made to match the external profile of other parts of the nozzle 1. The post exit surface 10 may also be curved axially to form an annular segment matching a circular portion of a circular jet exit.

Known aspects of the engine and nozzle are not described.

A number of non-limiting embodiments will now be described.

In the figures corresponding to the embodiments, the subscripts V for variable and F for fixed have been used. This indicates which of the active components is moveable in that embodiment, with corresponding dotted lines with arrows to indicate optional motion. Where the post exit surface 10 is variable (indicated by 10_{V}) this means the length d is variable.

FIG. 7 shows a first embodiment of the invention, with a nozzle 1 comprising a fixed throat aperture 8_{F}, variable exit aperture 9_{V}, and a fixed post exit surface 10_{F}.

This arrangement would suit a propulsion gas generator which does not require throat area A₈ variation across its operating range. Exit area A₉ variation is achieved through mechanical means, though could also be achieved by fluid injection close to the exit, or through any other means.

Such a design may be useful in a non-reheated gas turbine engine installed in a long-range combat aircraft. Jet vectoring could be used on tail-less or blended wing-body aircraft configurations to reduce trim drag as well as to generate control forces in flight regimes where the control power available from other controls is low, such as at take-off.

FIG. 8 shows a second embodiment of the invention, with a nozzle 1, comprising a fixed throat aperture 8_{F}, variable exit aperture 9_{V} and a variable post exit surface 10_{V}.

This configuration would extend the first to allow nozzle post-exit geometry to be set to maximise jet vector range at a given flight condition. It may suit a situation where a high jet vector angle δ range is required on a fighter aircraft at both dry and reheat conditions.

FIG. 9 shows a third embodiment of the invention, with a nozzle 1 comprising a variable throat aperture 8_{V}, variable exit aperture 8_{V}, and a fixed post exit surface 10_{F}.

This arrangement would suit a propulsion gas generator which requires throat area A₈ variation across its operating range. Variation of the throat aperture 8 and exit aperture 9 is achieved through mechanical means, though could be achieved by fluid injection or any other means.

An application for this embodiment would be in a reheated gas turbine engine installed in a combat aircraft. The throat aperture 8 is varied as required for engine operation. The expansion state of the jet is varied through changing exit aperture 9 to achieve the divergent area ratio necessary to set the required jet vector angle δ. Due to the large variation of the area of the exit aperture 9 inherent in this application, the size of the post exit surface 10 may benefit from being set according to the flight regime in which in which jet vectoring is most important.

FIG. 10 shows a fourth embodiment of the invention, with a nozzle 1 comprising a variable throat aperture 8_{V}, variable exit aperture 9_{V}, and a variable post exit surface 10_{V}.

This is an extension to the third embodiment. This configuration allows a nozzle post-exit geometry to be set to maximise jet vector range at a given flight condition. It may suit a situation where a large range of jet vector angles δ is required on a fighter aircraft at both dry and reheat conditions, since the throat aperture 8, exit aperture 9 and post exit surface 10 can all be controlled to maximise jet vectoring in any circumstance.

In this embodiment, the nozzle divergent area ratio (A₉/A₈) may be continuously varied to maximise thrust at any given flight speed, throttle setting and reheat setting, whilst further controlling them to also provide jet vectoring if required.

FIG. 11 shows a fifth embodiment of the invention, with a nozzle 1 comprising a fixed throat aperture 8_{F}, fixed exit aperture 9_{F}, and a variable post exit surface 10_{V}.

This embodiment may particularly suit a rocket or ram-jet engine installed in a high speed aircraft, spacecraft or weapon. These vehicles tend to feature high area-ratio fixed-geometry nozzles wherein the exit aperture 9 is substantially larger than the throat aperture 8. The expansion state of the jet flow 3 may vary between over-expansion at launch and a very high degree of under expansion during high speed, high altitude flight. Introducing one or more post-exit surface(s) in either regime would generate usable control forces.

FIG. 12 shows a sixth embodiment of the invention, with a nozzle comprising a variable throat aperture 8_{V}, fixed exit aperture 9_{F} and a fixed post exit surface 10_{F}.

This arrangement would suit an application where varying the properties and/or flow conditions of the gas may be used to vary the jet vector angle δ.

FIG. 13, FIG. 14, and FIG. 15 show a seventh embodiment of the invention, with a nozzle 1 comprising a variable throat aperture 8_{V}, a variable exit aperture 9_{V} and a variable post exit surface 10_{V}.

The forward end of the post exit surface 10_{V} is positioned adjacent the variable throat aperture 8_{V}. The post exit surface pivots at its forward end about pivot 12a, permitting rotation about an axis perpendicular to the transverse axis 2 of the engine. A portion of the according pivotal motion path 14 of the distal end is indicated.

Pivoting the post exit surface 10_{V} about point 12a causes the exit aperture 9_{V} to be varied.

FIG. 14 shows post exit surface 10_{V} pivoted upwards at the distal end about pivot 12a causing the jet flow 3 to be directed upwards, with an associated expansion fan 30 causing a further upward jet vector angle δ. The jet boundary 20 is shown.

FIG. 15 shows post exit surface 10_{V} pivoted downwards at the distal end about pivot 12a causing the jet flow 3 to be directed downwards, with an associated oblique shock wave 35 causing a further downward jet vector angle δ. The jet boundary 20 is shown.

Varying the angle of the post exit surface 10_{V} combines jet vectoring achieved through e.g. expansion with jet vectoring via a geometric rotation, significantly increasing the achievable maximum and minimum jet vector angles.

This embodiment may be further enhanced with a further articulation of the post exit surface 10_{V} at the exit (not shown).

Other permutations of active components are possible in conjunction with the pivotal motion of the post exit surface 10_{V}.

FIG. 16 and FIG. 17 show an eighth embodiment of the invention, with a nozzle 1 comprising a variable throat aperture 8_{V}, a variable exit aperture 9_{V} and a variable post exit surface 10_{V}.

The forward end of the post exit surface 10_{V} is positioned adjacent the throat aperture 8_{V}, positioned mid-way up the height of the throat aperture 8_{V} thus subdividing the exit aperture into two parts in such a way that deflection of the post exit surface 10_{V} causes expansion in one part whilst reducing it in the other. Post exit surface 10_{V} pivots at its forward end about pivot 12b, permitting rotation about an axis perpendicular to the transverse axis 2 of the engine. A portion of the according pivotal motion path 14 of the distal end is indicated.

Pivoting the post exit surface 10_{V} about point 12b causes the exit aperture 9_{V}.

This arrangement could be used to create a vectoring effect for a single nozzle or on multiple closely spaced nozzles.

FIG. 17 shows the post exit surface 10_{V} rotated upwards about pivot 12b, causing an expansion fan 30 to be generated in the top part 9a of exit aperture 9 and an oblique shock wave 35 to be generated in the bottom part 9b of the exit aperture 9. These two parts 9a, 9b function together to create a jet vector angle δ to the jet flow 3. Shrinking one part e.g. 9a will cause the other part e.g. 9b to expand, and vice versa.

An equivalent but opposite action occurs when the post exit surface 10_{V} is rotated downwards about pivot 12b.

The jet boundary 20 is shown.

FIG. 18 and FIG. 19 shows a ninth embodiment of the invention, with a nozzle 1 comprising a variable throat aperture 8_{V}, a variable exit aperture 9_{V} and a two variable post exit surfaces 10a,10b. Each post exit surface 10a,10b is independently moveable along a respective motion path 13a,13b to a retracted position. Each post exit surface 10a,10b may be pivoted about respective pivots 15a,15b, permitting rotation about of each about an axis perpendicular to the transverse axis 2 of the engine. A portion of the respective pivotal motion paths 14a, 14b of the distal ends is shown. FIG. 19 shows one post exit surface 10b moved into the retracted position, wherein remaining post exit surface 10a can act upon the jet flow to create a jet vector.

The post-exit surfaces may be retracted internally or externally relative to the aircraft body. Their variation and retraction may either be separate or linked-with variation of either or both of the apertures 8 and 9 as well as with the relative position of apertures 8 and 9.

In any embodiment with pivotal motion of the post exit surface 10 this can be achieved by one or more motors connected to gearing (not shown) at the front end. Alternatively linear actuators suitably positioned and connected between the a fixed portion of the nozzle 1 and to a part of the post exit surface 10 away from the forward end and can thus be used to provide the pivotal rotation.

In any embodiment with one or more retractable and extendible post exit surfaces 10, linear actuators (not shown) pull it forwards, towards the front of the engine until its distal end is broadly in line with the exit aperture 9. When in this position the top and bottom of the nozzle 1 lies on a single plane which is oriented normal to the longitudinal axis of the engine, causing a symmetric exit (when viewed from the side). The surface moves on swinging arms or over rollers and along guiding grooves or tracks on the inside or outside of the nozzle (also not shown).

To extend the post exit surface 10, the same actuators (not shown) that are used to retract it towards the front of the engine now push it backwards. The distance that it is moved backwards controls the length d of the post exit surface 10 relative to the exit aperture 9. The control means (not shown) is configured to prevent rotation of the post exit surface 10 until it is in the extended position, else it may contact and damage other parts. In the extended position the nozzle 1 is asymmetric.

Where a post exit surface 10 is not retractable to a stowed position but its length d is variable, this is achieved in a similar manner using linear actuators as discussed above. Since stowage is not required, a smaller range of motion is required but the method of creating longitudinal movement is the same.

The invention is designed specifically to exploit static pressure differences between ambient conditions and the region local to the nozzle exit aperture 9. As discussed above, these pressure differences may be deliberately created by controlling, or varying, via any means, the aerodynamic expansion state of the jet flow 3. These pressure differences, together with any non-axial shear forces acting on the same surfaces due to viscosity, will result in a lateral force component which exactly corresponds to the lateral change in momentum of the jet flow 3. The net result is a change of direction of the force produced by the jet on the aircraft and thus the invention permits jet vectoring.

Any exit pressure mismatch on this post exit surface 10 will result in a force acting on this post exit surface 10 with a corresponding change in direction of the jet vector 6, which may be uniform or non-uniform depending on flow conditions. The magnitude of this pressure force resolved in a direction normal to the axis 2 of the nozzle 1 will be equal to the lateral component of the jet vector.

The specific embodiments demonstrate some of the ways the invention can be implemented.

The basic principle of operation wherein an expansion fan 30 is generated in an under expanded state and one or more oblique shock waves 35 is generated in an over expanded state has been mentioned. The effect is now discussed in more detail.

The reader will appreciate the following explanation from their understanding of the high-speed flow of a compressible fluid, with reference to any suitable text book or standard reference source¹. Since the fluid dynamic principles herein are not novel in themselves, only in their application, they have not been described in great detail. ¹ ‘Equations, Tables, and Charts for Compressible Flow’ NACA Report 1135, 1953

By assuming isentropic flow, a simple idealised model of the flow turning behaviour, which in the current invention will be exploited to produce jet vectoring, at the exit aperture 9 may be written as:

$$δ = {tan}^{- 1} ( \frac{{A}_{ext} \cdot {p}_{9}}{{F}_{abs} - {A}_{9} \cdot {p}_{∞}} )$$

Where F_{abs} is the vacuum thrust of the nozzle 1 and Aₑₓₜ is the planform area of the nozzle extension. It is assumed that the flow at the plane of the nozzle throat 8 is sonic (i.e. M₈=1) and that the divergence of the nozzle walls between stations 8 and 9 is such that the flow remains fully attached. No corrections are made here for viscous effects.

There will, however, be some limits to the jet vectoring characteristics described by this idealised model and these are approximated here by considering some of the physical flow mechanisms present in different operating regimes:

When p₉<p_{∞}, flow turning may be dramatically reduced when the oblique shock wave which will be present across the nozzle exit impinges on the post exit surface 10. This condition will occur when:

$$\frac{{p}_{∞}}{{p}_{9}} = \frac{2 γ {M}_{9}^{2} {sin}^{2} β - ( γ - 1 )}{γ + 1} > 1.$$

Where M₉ is flow Mach number at the exit aperture 9 which is a function of A₉/A₈, β is the oblique shock wave 35 angle and γ is the ratio of specific heats of the exhaust gas.

When p₉≥p_{∞}, flow turning will gradually reduce once the incipient Mach line (31) of the Prandtl-Meyer expansion fan impinges on the post exit surface 10. This will first occur when:

$$tan β = \frac{1}{\sqrt{{{M}_{9}}^{2} - 1}}$$

When p₉>p_{∞}, flow turning will be further reduced once the terminal Mach line 32 of the Prandtl-Meyer expansion fan 30 impinges on the post exit surface 10. This will first occur when:

$${δ}_{fe} = {sin}^{- 1} ( \frac{1}{{M}_{9}} ) - θ$$

Where:

$$tan θ = \frac{e}{d} ,$$

and δ_{fe} is the net fully-expanded Prandtl-Meyer turning angle, assuming that the effect of the reflected expansion fan is small.

It will be appreciated that due to the way the jet vector angle δ is defined, a negative value indicates an ‘upward’ vector (in an instance where the post exit surface extends from the exit aperture 9 at the bottom), and vice versa.

To illustrate the effectiveness of the invention, a specific example is now provided where the post exit surface 10 has a post exit surface length d of one exit aperture height e (that is, the post exit surface 10 is as long as the exit aperture is high e: d/e=1). They are both fixed in size.

FIG. 20 Error! Reference source not found. illustrates the resulting jet vector angle δ against nozzle pressure ratio (H₉/p_{∞}) for a range of divergent area ratios (A₉/A₈). Since the exit height e and post exit surface length d are fixed and thus remain at a constant ratio of 1:1, throat aperture area A₈ is varied to change the area ratio A₉/A₈ and create a jet vector. This is equivalent to the embodiment shown in FIG. 12.

This illustrative example is simply to provide a ready understanding of how the technical effect can be achieved and exploited. In practice of course it will be useful to maintain freedom to vary the throat aperture 8 otherwise than for jet vectoring (e.g. for engine matching) and to instead vary the exit aperture 9 and post exit surface length d to provide the jet vectoring.

To illustrate the behaviour of the nozzle 1, a series of Computational Fluid Dynamics (CFD) calculations were performed using the Cobalt CFD code. The length and contour of a symmetric nozzle divergent section was defined in all of these calculations such that the velocity distribution at the exit aperture 9 was uniform. This idealisation was employed to enable direct comparison to be made between the idealised model and the results from the physics-based CFD model.

The chosen ratio of post exit surface length to exit height, d/e, was 1.0, the ratio of specific heats of the exhaust gas, γ, was 1.35. In the CFD model, dimensional nozzle exit height e was set at 0.3 m, ambient pressure was set at 10⁵ N/m² and free stream Mach number was set at 0.2.

The Reynolds Averaged Navier-Stokes (RANS) flow solver in Cobalt² was run with Menter's Shear Stress Transport turbulence model to predict the gas flow in the nozzle in two-dimensions. The CFD model could be expected to capture all of the important flow physics when the flow velocity is either constant or is increasing adjacent to air-swept surfaces. This can be expected to be the case at under-expanded conditions when the nozzle 1 is choked and no shock waves 35 impinge on any of the surfaces. When strong shock waves are present in the flow solution and the local Mach number ahead of the wave exceeds about 1.35, results can be expected to accurately capture the position at which flow separation will occur. At lower shock strengths a greater degree of uncertainty in the prediction of flow separation is likely to be present, but trends should be similar. Shock impingement is only likely to occur if the nozzle flow is over-expanded or if any post-exit extension is very long. ²‘Cobalt Manual’, Version 7, 2015, Cobalt Solutions LLC

FIG. 20 Error! Reference source not found. shows Error! Reference source not found. results for jet vector angle, δ, obtained using this idealised model (solid lines) and using Cobalt CFD (symbols with dashed lines) are compared for a range of nozzle divergent area ratios (A₉/A₈). At nozzle pressure ratios (H₉/p_{∞}) above about 3.5 and at higher values of A₉/A₈, it can be seen that the two models agree closely. Some effect of the presence of viscosity in the CFD model might be expected but this appears to be minimal, most likely since pressure gradient in the nozzle is always favourable and continuous. In the range at which 6 is positive and H₉/p_{∞} is below 3.5 the jet vector angle predicted by CFD reduces sharply compared to the idealised model. This reduction occurs due to shock induced flow separation from the post-exit extension. The locus of conditions at which an oblique shock first impinges on the surface (35), as predicted by the idealised model is shown. This agrees well with the CFD result for higher values of A₉/A₈ at which higher oblique shock strengths will occur.

This plot shows how variation of A₉/A₈ affects the possible jet vector angle δ which is achievable against H₉/p_{∞}. For example, a combination of H₉/p_{∞} of 5.5 and A₉/A₈ of 1.441 creates negligible jet vector angle δ, but by changing A₉/A₈ to 1.044 a jet vector angle in excess of 10° can be achieved.

FIG. 21 Error! Reference source not found. shows these results in the form of a shaded region which shows the envelope of jet vectoring angles δ that can be achieved against H₉/p_{∞}. The envelope is bounded by the sonic limit of the nozzle 38 (theoretically A₉/A₈=1.0 but in order to maintain the nozzle throat at a constant position this would need to be slightly greater than 1.0), the chosen upper limit 37 of A₉/A₈ and the limit of flow attachment 36 to the post-exit surface. The final boundary would be the pressure ratio limit of the gas generator which is shown here, arbitrarily, as 10.

In FIG. 22 and FIG. 23 the post exit surface length d was held constant and two values of throat height, t, were chosen to represent reheat and dry power settings, respectively, of a gas turbine engine. The ratio of throat areas between reheat and dry settings was 1.6. The ratio of specific heats, γ, was chosen as 1.26 for reheat and 1.35 for dry settings. At each of these settings the exit height, e, is was varied independently to represent changes in area ratio at these two power settings. In each case the upper limit of area ratio was set at 1.44, as before, though in practise a greater area ratio than this would probably be achievable at the dry setting in a nozzle of this type. In both plots, region 41 corresponds to over-expanded jet conditions and is bounded by the upper limit of area ratio, the flow separation boundary and the axis δ=0. Similarly, region 42 corresponds to under-expanded jet conditions and is bounded by the upper and lower limits of area ratio, the axis δ=0 and the upper limit of pressure ratio.

Now, the important post-exit proportions of the nozzle, characterised by the ratio d/e, are dependent on both power setting and area ratio A₉/A₈ (instead of d/e being constant as in the previous example), e.g. if e/t=A₉/A₈ then:

$$\frac{d}{e} = \frac{d}{t} \cdot \frac{{A}_{8}}{{A}_{9}}$$

The resulting envelopes are somewhat expanded in jet vector angle range. A negative vector angle of −6 to −8 degrees is available in reheat at pressure ratios typical of low speed flight such as take-off rotation, together with a modest positive range. At pressure ratios representative of subsonic combat a jet vector range of −8 to −10 degrees is available in reheat. By changing the post exit surface length d the relative jet vector ranges at dry and reheat can be changed to favour one setting or the other.

At pressure ratios corresponding to supersonic flight, where most aircraft will require a large nose-up pitching moment to maintain trim, perhaps corresponding to a jet vector angle of −5 to −8 degrees in dry power, the nozzle would maintain an available margin of at least around a further −5 degrees. In this regime the nozzle would be likely to be operating at or close-to its upper area ratio limit so this may become a driver for that limit.

FIG. 24 provides an illustration of the effect of variable geometry such as in the ninth embodiment. Here the geometry may be varied such that the full under-expanded jet vectoring envelope 42 is achievable in both positive and negative directions for both reheat and dry power settings.

1. A propulsive gas generator for use in an air vehicle comprising a front end for receiving air, a back end for expelling air to form a propulsive jet flow, and a longitudinal axis between the front end and back end, a nozzle at the back end, said nozzle comprising an internal throat aperture and an exit aperture at the back end, wherein the throat aperture and the exit aperture each comprising an aperture size wherein the propulsive gas generator is configurable to provide a co-operating post exit surface extending to a rear of the exit aperture, wherein the post exit surface comprises a length and a width, and a forward end oriented towards the front end of the gas generator and a distal end furthest from the front end of the gas generator, wherein at least one of the throat aperture, exit aperture, and post exit surface length are configured to be variable, the propulsive gas generator further comprising control means for controlling the size of the at least one of the throat aperture, exit aperture or post exit surface length, wherein the control means is configured to receive an input signal, and in response to the input signal vary the size of at the at least one of the throat aperture, exit aperture and post exit surface length to create a pressure differential on the post exit surface thereby angling the propulsive jet flow relative to the longitudinal axis.

2. The propulsive gas generator as claimed in claim 1 wherein the at least one of the throat aperture, exit aperture and post exit surface length comprises the post exit surface length and which is configured to be varied in size by the control means.

3. The propulsive gas generator as claimed in claim 2 wherein the post exit surface length is configurable in size to between 0.5 and 1.5 times a fixed aperture size or maximum aperture size of the exit aperture.

4. The propulsive gas generator as claimed in claim 1 wherein the post exit surface length substantially matches a fixed aperture size or maximum aperture size of the exit aperture.

5. The propulsive gas generator as claimed in claim 1, wherein the nozzle is adapted to be rotatable relative to the longitudinal axis of the propulsive gas generator.

6. The propulsive gas generator as claimed in claim 1, wherein the post exit surface is configurable to be enclosed at the sides.

7. The propulsive gas generator as claimed in claim 1, wherein the post exit surface is angled such that the distal end is closer to the longitudinal axis of the propulsive gas generator than the forward end.

8. The propulsive gas generator as claimed in claim 1 wherein the post exit surface is pivotable at the forward end such that the angle of the post exit surface is variable with respect to the longitudinal axis of the propulsive gas generator.

9. The propulsive gas generator as claimed in claim 1, wherein the forward end of the post exit surface is configurable to be positioned adjacent the exit aperture.

10. The propulsive gas generator as claimed in claim 9 wherein the exit aperture is substantially circular in shape, and the forward end of the post exit surface is configurable to be positioned adjacent an exterior circumference of the exit aperture.

11. The propulsive gas generator as claimed in claim 8 wherein the forward end of the post exit surface is configurable to be positioned adjacent the throat aperture.

12. The propulsive gas generator as claimed in claim 11 wherein the throat aperture is substantially circular in shape, and the forward end of the post exit surface is configurable to be positioned adjacent an exterior circumference of the throat aperture.

13. The propulsive gas generator as claimed in claim 11 wherein the forward end of the post exit surface is positioned approximately centrally to the throat aperture.

14. The propulsive gas generator as claimed in claim 1 wherein the post exit surface is configured to be extendible to an operative position forming an asymmetric exit, and retractable to a stowed position forming a substantially symmetric exit.

15. The propulsive gas generator as claimed in claim 14 wherein the gas generator comprises two or more post exit surfaces each configured to be extendible to an operative position forming an asymmetric exit, and retractable to a stowed position forming a substantially symmetric exit.

16. The propulsive gas generator as claimed in claim 1, wherein the nozzle comprises the post exit surface.

17. The propulsive gas generator as claimed in claim 1, wherein the propulsive gas generator is a gas turbine.

18. An aircraft comprising the propulsive gas generator according to claim 1.
